(19) United States
(12) Patent Application Publication
(10) Pub. No.: US 2016/0124786 A1
(43) Pub. Date: May 5, 2016

(54) METHODS FOR IDENTIFYING RACE CONDITION AT RUNTIME AND DEVICES THEREOF

(71) Applicant: NetApp, Inc., Sunnyvale, CA (US)

(72) Inventor: An Zhu, Cary, NC (US)

(21) Appl. No.: 14/532,184

(22) Filed: Nov. 4, 2014

(51) Int. Cl. G06F 11/07

(52) U.S. Cl. CPC G06F 11/079; G06F 11/0721; G06F 11/0757; G06F 11/0772

(57) ABSTRACT

A method, non-transitory computer readable medium, and device that identifies race condition at run time includes monitoring a client device processor during execution of an operation by the client device processor. An interrupt in the monitored client device processor is identified and a delay is introduced in the monitored client device processor during the execution of the monitored client device processor upon identifying the interrupt. A race condition in a completed operation is determined using information associated with the introduced delay. Information associated with the race condition is recorded when the completed operation is determined to have resulted in the race condition.

### FIELD

This technology relates to identifying race condition at runtime and devices thereof.

### BACKGROUND

A race condition is a behavior of an electronic or software system where the output is dependent on the sequence or timing of other uncontrollable events. It becomes a bug when the events do not happen in the order the events were intended to execute. Therefore, when there is a race condition in a software system, it is extremely important to analyze and identify the reason for the race condition. Unfortunately, it is never easy to reproduce and debug race conditions because it highly depends on the relative timing between multiple events.

Prior technologies have tried to address this race condition issue through careful software coding and design. However, due to human errors, it is becomes very difficult to prevent all the possible race conditions. Additionally, even when the race condition is detected, prior technologies have been unable to effectively re-create the sequence of steps that resulted in the race condition.

### SUMMARY

A method for method for identifying race condition at runtime includes monitoring, by a storage management computing device, a client device processor during execution of an operation by the client device processor. An interrupt in the monitored client device processor is identified by the storage management computing device and a delay is introduced in the monitored client device processor during the execution of the monitored client device processor upon identifying the interrupt. A race condition in a completed operation is determined by the storage management computing device using information associated with the introduced delay. Information associated with the race condition is recorded by the storage management computing device when the completed operation is determined to have resulted in the race condition.

A non-transitory computer readable medium having stored thereon instructions for identifying race condition at runtime comprising executable code which when executed by a processor, causes the processor to perform steps including monitoring a client device processor during execution of an operation by the client device processor. An interrupt in the monitored client device processor is identified and a delay is introduced in the monitored client device processor during the execution of the monitored client device processor upon identifying the interrupt. A race condition in a completed operation is determined using information associated with the introduced delay. Information associated with the race condition is recorded when the completed operation is determined to have resulted in the race condition.

A storage management computing device includes a processor and a memory coupled to the processor which is configured to be capable of executing programmed instructions comprising and stored in the memory to monitor a client device processor during execution of an operation by the client device processor. An interrupt in the monitored client device processor is identified and a delay is introduced in the monitored client device processor during the execution of the monitored client device processor upon identifying the interrupt. A race condition in a completed operation is determined using information associated with the introduced delay. Information associated with the race condition is recorded when the completed operation is determined to have resulted in the race condition.

This technology provides a number of advantages including providing methods, non-transitory computer readable medium and devices for identifying race condition at runtime. By introducing delay, the technology disclosed herein is able to quickly and effectively identify a race condition during runtime. Additionally, the technology is also able to reconstruct the race condition using the delay information.

### BRIEF DESCRIPTION OF THE DRAWINGS

FIG. 1 is a block diagram of an environment with an exemplary storage management computing device;

FIG. 2 is a block diagram of the exemplary storage management computing device shown in FIG. 1;

FIG. 3 is a flow chart of an example of a method for identifying race condition at runtime;

FIG. 4 is exemplary illustrations of a pseudo code used to identify race condition at runtime;

FIG. 5 is an exemplary illustration of a successful completion of the received request; and

FIG. 6 is an exemplary illustration of a race condition identified during runtime.

### DETAILED DESCRIPTION

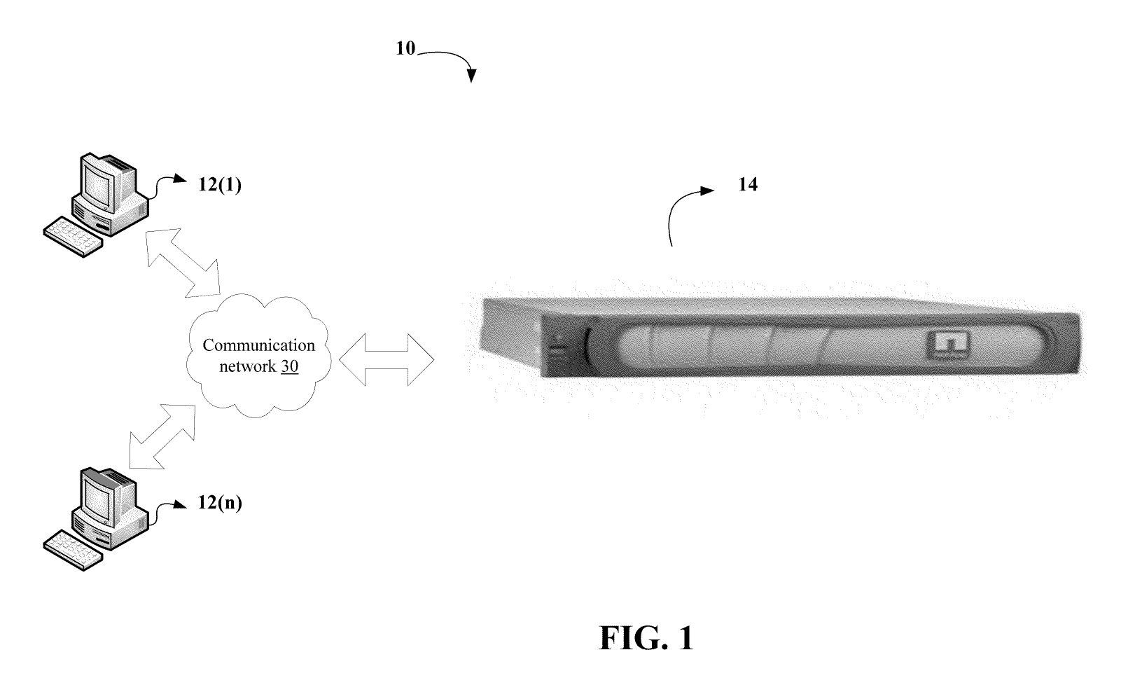

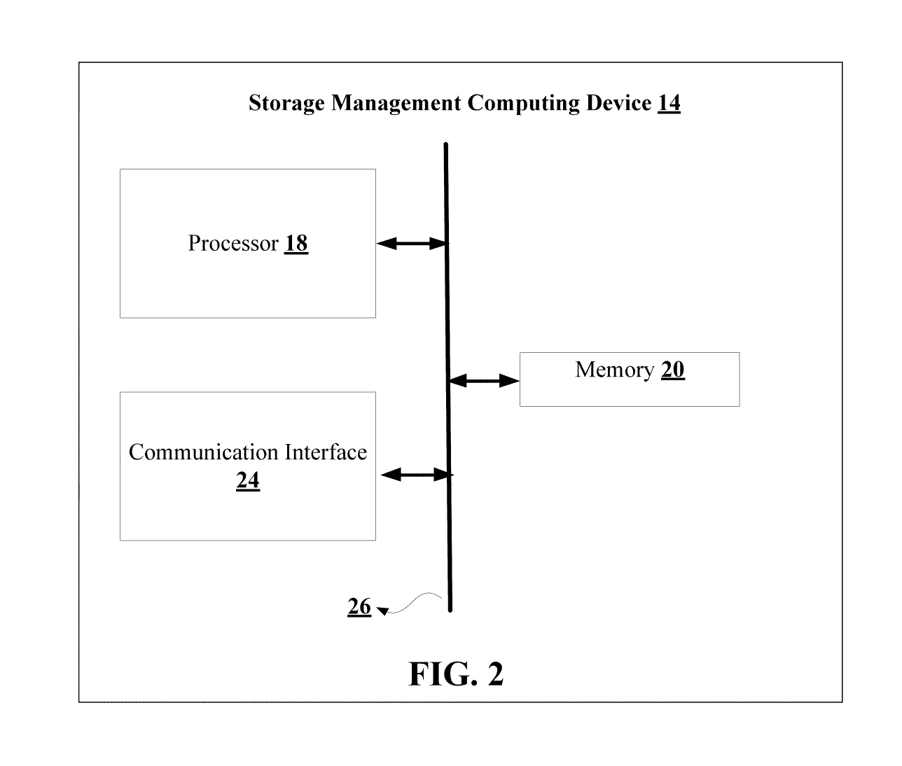

An environment 10 with a plurality of client computing devices 12(1)-12(n) and an exemplary storage management computing device 14 is illustrated in FIGS. 1-2. In this particular example, the environment 10 includes a plurality of client computing devices 12(1)-12(n), and the storage management computing device 14 coupled via one or more communication networks 30, although the environment could include other types and numbers of systems, devices, components, and/or other elements. In this example, the method for identifying race condition at runtime is executed by the storage management computing device 14 although the approaches illustrated and described herein could be executed by other systems and devices. The environment 10 may include other types and numbers of other network elements and devices, as is generally known in the art and will not be illustrated or described herein. This technology provides a number of advantages including providing methods, non-transitory computer readable medium and devices for identifying race condition at runtime.

Referring more specifically to FIG. 2, in this example the storage management computing device 14 includes a processor 18, a memory 20, and a communication interface 24 which are coupled together by a bus 26, although the storage management computing device 14 may include other types and numbers of elements in other configurations.

The processor 18 of the storage management computing device 14 may execute one or more programmed instructions stored in the memory 20 for replicating data and providing instantaneous access to data as illustrated and described in the examples herein, although other types and numbers of functions and/or other operation can be performed. The processor 18 of the storage management computing device 14 may include one or more central processing units (“CPUs”) or general purpose processors with one or more processing cores, such as AMD® processor(s), although other types of processor(s) could be used (e.g., Intel®).

The memory 20 of the storage management computing device 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

The communication interface 24 of the storage management computing device 14 operatively couples and communicates with the plurality of client computing devices 12(1)-12(n), which are all coupled together by the communication network 30, although other types and numbers of communication networks or systems with other types and numbers of connections and configurations to other devices and elements. By way of example only, the communication network 30 can use TCP/IP over Ethernet and industry-standard protocols, including NFS, CIFS, SOAP, XML, LDAP, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like. In this example, the bus 26 is a universal serial bus, although other bus types and links may be used, such as PCI-Express or hyper-transport bus.

Each of the plurality of client computing devices 12(1)-12(n) includes a central processing unit (CPU) or processor, a memory, an interface device, and an I/O system, which are coupled together by a bus or other link, although other numbers and types of network devices could be used. The plurality of client computing devices 12(1)-12(n) communicates with the storage management computing device 14 for requesting access to data, although the client computing devices 12(1)-12(n) can interact with the storage management computing device 14 for other purposes. By way of example, the plurality of client computing devices 12(1)-12(n) may run interface application(s) that may provide an interface to make requests to access, modify, delete, edit, read or write data within storage management computing device 14 via the communication network 30.

Although the exemplary network environment 10 includes the plurality of client computing devices 12(1)-12(n), and the storage management computing device 14 described and illustrated herein, other types and numbers of systems, devices, components, and/or other elements in other topologies can be used. It is to be understood that the systems of the examples described herein are for exemplary purposes, as many variations of the specific hardware and software used to implement the examples are possible, as will be appreciated by those of ordinary skill in the art.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

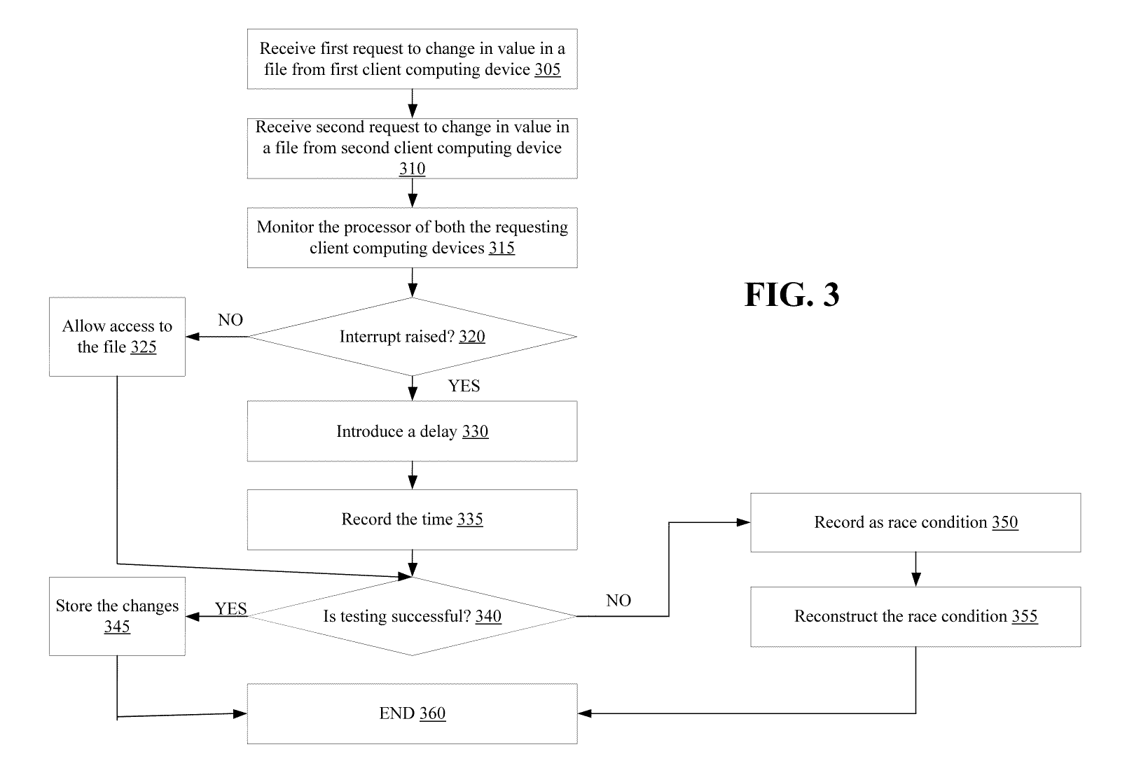

An exemplary method for identifying race condition at runtime will now be described herein with reference to FIGS. 1-6. Particularly with reference to FIG. 3, in step 305, the storage management computing device 14 receives a first request from one of the plurality of client computing devices 12(1)-12(n) to increment the value of an integer by one in a file stored in the memory 20 of the storage management computing device 14, although the storage management computing device 14 can receive other types or amounts of requests. For purposes of illustration only, the storage management computing device 14 in this particular example receives the first request from the client computing device 12(1) among the plurality of client computing devices 12(1)-12(n).

In step 310, in this particular example the storage management computing device 14 receives a second request from another one of the plurality of client computing devices 12(1)-12(n) to increment the value of an integer by one in the same file as requested by the client computing device 12(1). For purposes of illustration only, the storage management computing device 14 in this particular example receives the second request from the client computing device 12(2), among the plurality of client computing devices 12(1)-12(n). Alternatively, in another example, the storage management computing device 14 could receive two requests from two different processors within the same one of the plurality of client computing devices 12(1)-12(n).

In step 315, in this particular example the storage management computing device 14 simultaneously monitors the processor within both of the requesting client computing devices 12(1) and 12(2). By way of example only, the storage management computing device 14 monitors the processor within the requesting client computing devices 12(1) and 12(2) for interrupt(s) raised by the processor within each of the requesting client computing devices 12(1) and 12(2), although the storage management computing device 14 can monitor the processor for other types and/or numbers of operations and/or functions of the processor. As it would be appreciated by one of ordinary skill in the art, an interrupt is a signal raised by the processor or other hardware indicating an event that requires immediate attention.

Next in step 320, in this particular example the storage management computing device 14 determines when an interrupt is raised by the processor in one or both of the requesting client computing devices 12(1) and 12(2). As previously illustrated in step 315, in this particular example the storage management computing device 14 monitors the processor within the requesting client computing devices 12(1) and 12(2) to identify the occurrence of this interrupt. Accordingly, if the storage management computing device 14 determines there was no interrupt raised by the processor in one or both of the requesting client computing devices 12(1) and 12(2), then the No branch is taken to step 325.

In step 325, in this particular example the storage management computing device 14 allows the both the requesting client computing devices 12(1) and 12(2) to increment the integer value within the same file by one, although the storage management computing device 14 can allow the requesting client computing devices 12(1) and 12(2) to perform other types of operations on the file. For purpose of illustration only, in this particular example the steps taken by the processor of the requesting client computing devices 12(1) and 12(2) to complete the operation of incrementing the integer value by one is to first read the existing value in the file, increment the value in the file by one and write back the increment value back to the file. Additionally, the storage management computing device 14 continues to monitor the processor within each of the requesting client computing devices 12(1) and 12(2) for any interrupt while the requesting client computing devices 12(1) and 12(2) are performing their operations on the file. In this particular example, the storage management computing device 14 introduces a delay to a processor in at least one of the requesting client computing devices 12(1) and 12(2) while completing the operation, although other types and/or numbers of operations or other functions could be introduced.

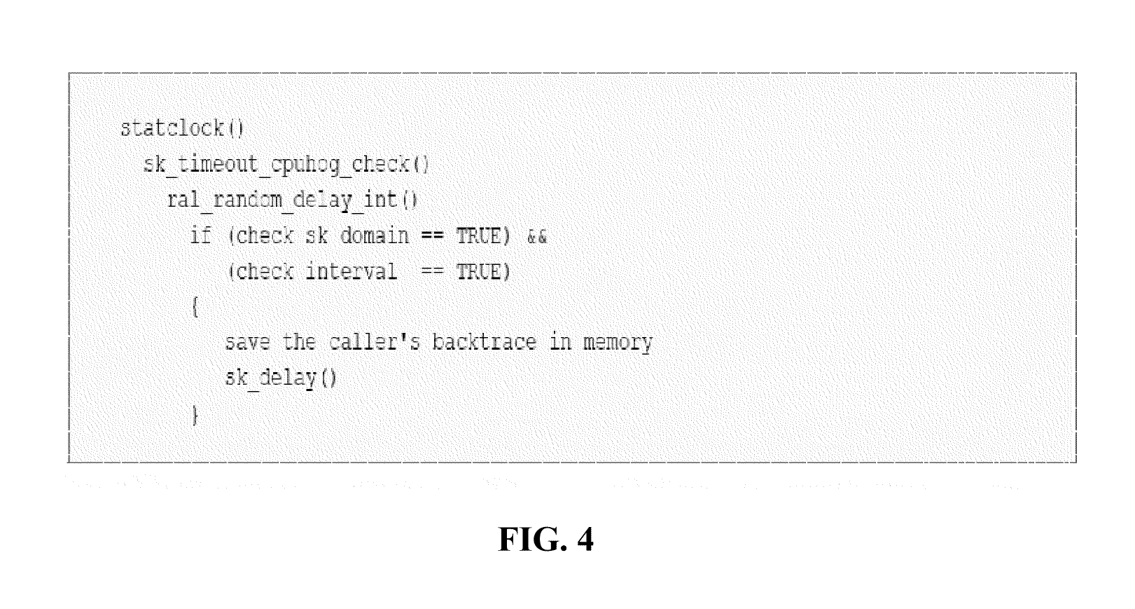

However, if back in step 320 the storage management computing device 14 determined there was an interrupt raised by processor in one or both the requesting client computing devices 12(1) and 12(2), then the Yes branch is taken to step 330. In step 330, the storage management computing device 14 introduces a delay in the execution of the processor of the requesting client computing devices 12(1) and 12(2) which raised the interrupt. In this example, delay relates to a message sent to the processor from the storage management computing device 14 indicating that no operation is required to be performed by the processor until the length of the delay terminates. In this example, the length of the delay introduced by the storage management computing device 14 can be easily configured. An exemplary illustration of an introduced delay is illustrated in FIG. 4, although other types of delays can be introduced by the storage management computing device 14. By way of example only, the delay illustrated in FIG. 4 is a call back function to a function called statlock( ) which spins delays for a random configurable length. This delay is inserted within the code execution path of the processor raising the interrupt in the requesting client computing devices 12(1) and 12(2). Additionally, as previously illustrated, the storage management computing device 14 continues to monitor the processor in the requesting client computing devices 12(1) and 12(2) and introduces a delay whenever there is an interrupt raised by the processor in the requesting client computing devices 12(1) and 12(2).

Alternatively in another example, the storage management computing device 14 can raise introduce a delay in the processor of both requesting client computing devices 12(1) and 12(2) when the processor in one requesting client computing device raises an interrupt.

In yet another example, the storage management computing device 14 can introduce a delay at periodic instant of time to all the processors it is monitoring during the execution of an operation without waiting for the processor in the requesting client computing devices 12(1) and 12(2) to raise an interrupt. By way of example only, the storage management computing device 14 can introduce a delay every eight milliseconds.

In a further example, the storage management computing device 14 can introduce a delay in the processor of the requesting client computing devices 12(1) and 12(2) when the processor in the requesting client computing devices 12(1) and 12(2) has completed certain percentage of execution or during a specific operation or operations.

As yet a further example, the storage management computing device 14 can introduce the delay when the processor of the requesting client computing devices 12(1) and 12(2) raises an interrupt and upon the termination of the periodic instant of time. Furthermore, the storage management computing device 14 can introduce a delay during a combination of two or more of the above illustrated examples or other types of delays.

Next in step 335, in this particular example the storage management computing device 14 records the time, place and length of the delay introduced within a delay table stored in the memory 20, although the storage management computing device 14 can record other types and/or amounts of information associated with the introduced delay using other techniques.

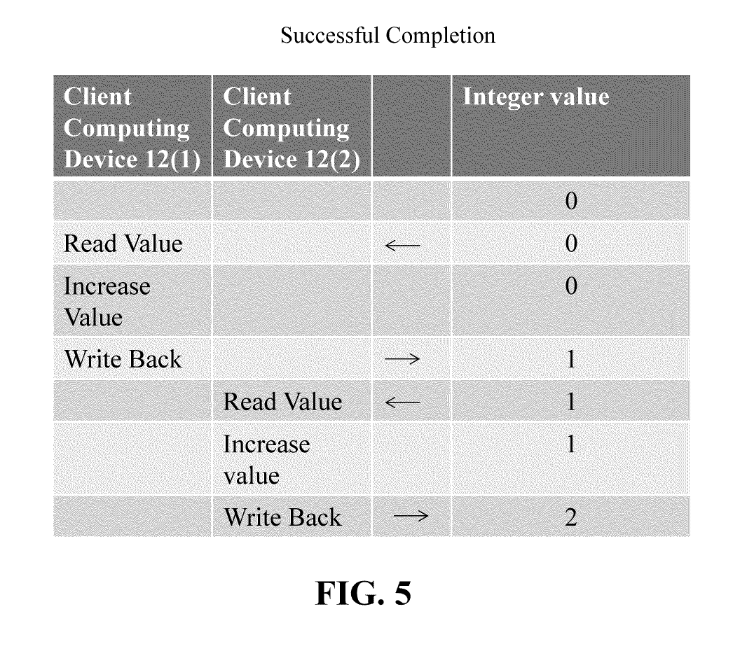

In step 340, in this particular example the storage management computing device performs a testing operation on the file. In this particular example, the requesting client computing device 12(1) sends the first request to increment the integer value in the file by one and then the other requesting client computing device 12(2) sends the second request to increment the integer value in the file by one. By way of example only, when the initial integer value in the file is zero and the above two requests are completed sequentially, the resulting integer value should be equal to two. This example of a successful completion is illustrated in FIG. 5.

In this example in FIG. 5, the requesting client computing device 12(1) first increments the integer value from zero to one and then writes back into the file to complete the first request. Next, the requesting client computing device 12(2) increments the value from one to two and then writes back the integer value back to the file. Accordingly, when the resulting value of the integer is two, the storage management computing device 14 determines that the testing was successful and the operations were completed without any race condition being identified. In this example, the storage management computing device 14 determines that the testing was not successful when the resulting integer value is not equal to two.

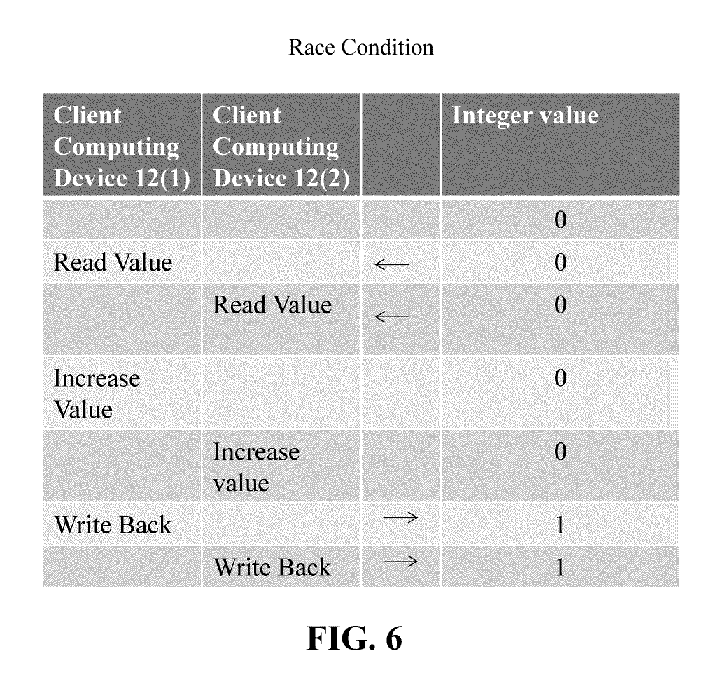

An example illustrating a failure in the testing is illustrated in FIG. 6. For purposes of illustration only, in this particular example illustrated in FIG. 6 the failure in the testing results when both of the requesting client computing devices 12(1) and 12(2) try to read, increment and write back the integer value at the same time as opposed to executing these operations sequentially.

Accordingly, if the storage management computing device 14 determines that the test was successful, then the Yes branch is taken to step 345. In step 345, the storage management computing device 14 stores the changes in the file within the memory 20 and the exemplary method ends in step 360.

However, if back in step 340 the storage management computing device 14 determines that the testing was not successful, then the No branch is taken to step 350. In step 350, the storage management computing device 14 identifies the failure of the testing as a race condition and records the information within a race condition table in the memory 20, although the storage management computing device 14 can record the race condition at other memory locations. In this particular example, the storage management computing device 14 records the time, type of operation and the processor performing the operation as part of recording race condition, although the storage management computing device 14 can record other types of information associated with the race condition.

In step 355, in this particular example the storage management computing device 14 assists with reconstructing the sequence of steps that resulted in the race condition using the most recent information within the delay table, although the storage management computing device 14 can use other types or amounts of information to reconstruct the sequence of steps that resulted in the race condition. As previously illustrated in this particular example, the delay table includes information relating to the delay that was introduced by the storage management computing device 14 during the operations performed by the processors of the requesting client computing devices 12(1) and 12(2). By way of example only and for purpose of further illustration with reference to FIG. 6, if storage management computing device 14 introduced a delay in the processor of the requesting client computing device 12(1) when it completed the read operation. This delay also resulted in the requesting client computing devices 12(2) also completing the read operation on the integer value in the file prior to completion of the delay length imposed on the processor in the requesting client computing device 12(1). As a result, the storage management computing device 14 reconstructs the correct sequence of steps using the information in the delay table.

Accordingly, as illustrated and described with reference to the examples herein, this technology provides methods, non-transitory computer readable medium and devices that are able to identify race condition during run time. By introducing delay, the technology disclosed herein is able to quickly and effectively identify race condition during runtime. Additionally, the technology is also able to reconstruct the race condition using the delay information.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for identifying race condition at runtime, the method comprising:
monitoring, by a storage management computing device, a client device processor during execution of an operation by the client device processor;
identifying, by the storage management computing device, an interrupt in the monitored client device processor and introducing a delay in the monitored client device processor during the execution of the monitored client device processor upon identifying the interrupt;
determining, by the storage management computing device, when a completed operation has resulted in a race condition using information associated with the introduced delay; and
recording, by the storage management computing device, information associated with the race condition when the completed operation is determined to have resulted in the race condition.

2. The method as set forth in claim 1 wherein the recording further comprises, recording, by the storage management computing device, the introduced delay within a delay table.

3. The method as set forth in claim 1 wherein the introducing the delay further comprises, recording, by the storage management computing device, information associated with the introduced delay.

4. The method as set forth in claim 1 further comprising reconstructing, by the storage management computing device, a sequence of steps that resulted in the race condition using the information associated with the introduced delay.

5. The method as set forth in claim 1 wherein the introducing the delay further comprises, introducing the delay during the execution of the operation.

6. The method as set forth in claim 1 wherein the introducing the delay further comprises, introducing the delay at a periodic instant of time during the execution of the operation.

7. A non-transitory computer readable medium having stored thereon instructions for identifying race condition at runtime comprising executable code which when executed by a processor, causes the processor to perform steps comprising:
monitoring a client device processor during execution of an operation by the client device processor;
identifying an interrupt in the monitored client device processor and introducing a delay in the monitored client device processor during the execution of the monitored client device processor upon identifying the interrupt;
determining when a completed operation has resulted in a race condition using information associated with the introduced delay; and
recording information associated with the race condition when the completed operation is determined to have resulted in the race condition.

8. The medium as set forth in claim 7 wherein the recording further comprises, recording the introduced delay within a delay table.

9. The medium as set forth in claim 7 wherein the introducing the delay further comprises, recording information associated with the introduced delay.

10. The medium as set forth in claim 7 further comprises reconstructing a sequence of steps that resulted in the identified race condition using the information associated with the introduced delay.

11. The medium as set forth in claim 7 wherein the introducing the delay further comprises, introducing the delay during the execution of the operation.

12. The medium as set forth in claim 7 wherein the introducing the delay further comprises, introducing the delay at a periodic instant of time during the execution of the operation.

13. A storage management computing device comprising:
a processor;
a memory coupled to the processor which is configured to be capable of executing programmed instructions comprising and stored in the memory to:
monitor a client device processor during execution of an operation by the client device processor;
identify an interrupt in the monitored client device processor and introducing a delay in the monitored client device processor during the execution of the monitored client device processor upon identifying the interrupt;
determine when a completed operation has resulted in a race condition using information associated with the introduced delay; and
record information associated with the race condition when the completed operation is determined to have resulted in the race condition.

14. The device as set forth in claim 13, wherein the processor coupled to the memory is further configured to capable of executing the programmed instructions further comprising and stored in the memory to record the introduced delay within a delay table.

15. The device as set forth in claim 13, wherein the processor coupled to the memory is further configured to capable of executing the programmed instructions further comprising and stored in the memory to record information associated with the introduced delay.

16. The device as set forth in claim 13, wherein the processor coupled to the memory is further configured to be capable of executing at least one additional programmed instruction comprising and stored in the memory to reconstruct a sequence of steps that resulted in the identified race condition using the information associated with the introduced delay.

17. The device as set forth in claim 13, wherein the processor coupled to the memory is further configured to capable of executing the programmed instructions further comprising and stored in the memory to introduce the delay during the execution of the operation.

18. The device as set forth in claim 13, wherein the processor coupled to the memory is further configured to capable of executing the programmed instructions further comprising and stored in the memory to introduce the delay at a periodic instant of time during the execution of the operation.
